(19) United States
(12) Patent Application Publication
(10) Pub. No.: US 2026/0232533 A1
(43) Pub. Date: Aug. 13, 2026

(54) A DEVICE FOR TRANSFERRING A MEDICAL FLUID

(71) Applicant: HEALTH & SAFETY SOLUTIONS SPA, SANTIAGO (CL)

(72) Inventor: FRANCISCO JOSÉ MARÍA BUSTOS VIAL, SANTIAGO (CL)

(21) Appl. No.: 19/168,217

(22) PCT Filed: Mar. 27, 2024
(86) PCT No.: PCT/EP2024/058368

§ 371 Date: Sep. 23, 2025

(30) Foreign Application Priority Data
Mar. 28, 2023 (EP) 23382294.9

(51) Int. Cl. A61J 1/20

(52) U.S. Cl. CPC A61J 1/2096

(57) ABSTRACT

A device for transferring a medical fluid which includes a hermetic housing having a body and a deformable portion sealingly attached to the body. The device also includes a connecting port which is arranged at the deformable portion and configured to receive and sealingly attach a fluid transfer instrument. The device further includes one or more support assemblies configured to attach a medical fluid container containing a medical fluid inside the body and one or more outlet ports arranged at the body.

The present disclosure relates to a device for transferring a medical fluid. The present disclosure also relates to a kit and a method for transferring a medical fluid.

### BACKGROUND

Currently, the standard process of preparing oncological drugs, prior to administration to the patient, requires this drug to be handled and mixed. In fact, the drug must be removed from its container and mixed with serum for administration to the patient, which represents a risk for the operators, such as laboratory or healthcare personnel, who handle the drug, as these drugs are hazardous substances. Examples of hazardous drugs are chemotherapy drugs used in the treatment of cancer and other antineoplastic treatments such as immunosuppressants, biological therapy, among others. The current standard process seeks to mitigate the risks of exposure to the drug in order to avoid generating future pathologies in these operators.

This standard process usually requires a plant with three rooms interconnected by positive pressure air flows and filtering for reducing the particulate material. Between these rooms, the personnel circulate under increasingly strict sanitary measures and specialised clothing until they enter the room equipped with a biosafety cabin with laminar air flow (workbench with air curtain) where the oncology preparation process is carried out.

Even when all these safety measures are implemented to protect the operator, scientific studies have reported that there is evidence of traces of oncology drugs in the blood and urine of the operators, and traces of these drugs are also found on different surfaces in the production plant. Thus, the standard process does not guarantee total safety for the operators, adding to the potential risk of suffering accidents due to direct exposure to the drug when handling them.

Furthermore, this process also requires a large, specialized infrastructure and specific supplies (e.g. syringes, vials) to be able to perform the task of mixing the drug with an intravenous bag (IV bag or serum bag) to be subsequently administered to the patient; as well as the compliance with regulations and work protocols that translate into high investment costs in the areas of infrastructure, maintenance of specialised equipment, supplies, certification, staff training, etc. Hence, this standard process is highly complex and consists of a series of steps that involve an excessive amount of qualified personnel time, especially a professional pharmacist and qualified technical staff.

In brief, the standard process entails a high investment and maintenance cost for oncology centers, long execution time of protocols, and does not provide a total safety for operators against exposure to these drugs. Therefore, there is a risk for the operators of developing health problems in the medium-long term such as infertility, teratogenicity, cancer, among others.

There are two types of alternatives solutions on the market to carry out this process:
1) Devices that complement the current standard process: These devices are focused on reduce potential points of exposure to the drug by creating additional barriers between the operator and the drug. Said devices are disposable but have to be used only once and require a large number of complementary parts for their interconnection. Hence, this solution represents additional steps to those already used in the standard process and adds even more costs, which is why only a minority of hospitals have incorporated these technologies.
2) Solutions that replace the current standard process: This arrangement comprises automated machinery for oncological preparations that replaces the current standard process in which operators load the supplies and the machine carries out the extraction and mixing process of the drugs under optimal and precise safety conditions (according to formulation indications). However, this solution has a high cost of acquisition, supplies and maintenance, which is sustainable only for institutions that have a high volume of production and have the capital investment.

Therefore, there is a need to prepare intravenous medicaments, in particular oncologic preparations, in a safety manner for the operators, and also in a quickly manner and at a lower cost.

### SUMMARY

According to one aspect of the present disclosure, a device for transferring a medical fluid is provided. The device comprises:
a hermetic housing comprising
   a body provided with at least a wall; and
   a deformable portion sealingly attached to the body to define a hermetical internal volume;
a connecting port arranged at the deformable portion, the connecting port configured to receive and sealingly attach a fluid transfer instrument to be operated from the outside of the hermetic housing;
one or more support assemblies configured to attach a medical fluid container containing a medical fluid to an inner side of the at least a wall of the body of the hermetic housing; and
   one or more outlet ports arranged at the body and configured to selectively communicate the inside of the hermetic housing with the outside thereof; and
      wherein the deformable portion is configured to deform in such way that when the fluid transfer instrument is sealingly attached to the connecting port, the deformable portion moves the connecting port between
a loading position for retrieving a dose of the medical fluid from the medical fluid container with the fluid transfer instrument; and
a discharging position for transferring the retrieved dose of the medical fluid to the outlet ports from the fluid transfer instrument.

In the present disclosure, a “fluid transfer instrument” is understood as a medical instrument capable to load a dose of a medical fluid and to discharge said dose, e.g. to be injected to a patient. An example of a fluid transfer instrument is a syringe. Typically, a syringe comprises a barrel (cylindrical tube) with a plunger (or piston), and a needle to be connected to the barrel in a sealingly manner (e.g. by a luer lock). The plunger is displaceable inside the barrel between a first direction (outwards) for drawing fluid into the syringe and a second direction (inwards) tor expelling fluid from the syringe. The needle is formed by a hollow shaft with a distal bevel end. The needle also includes a protective cover removable before use. The barrel and the plunger include respectively a flange to be handle by an operator.

In the present disclosure, a “medical fluid” is understood as a liquid pharmaceutical product (e.g. hazardous medicines or drugs for oncological treatments) to be administered to a patient intravenously. For example, the hazardous drugs may be chemotherapy drugs used in the treatment of cancer and other antineoplastic treatments such as immunosuppressants, biological therapy, among others.

It is noted that the “medical fluid” may be either a medical product in a liquid state, or a medical product in a powdered form which has been submitted to a reconstitution.

By “reconstitution” it is understood the process of adding a solvent or diluent to a medicine in powdered form, in other to dissolve it and prepare a liquid solution to be administered to a patient. The solvent or diluent may be for example a sterile saline solution or serum.

In the present disclosure, to carry out the process of transferring the medical liquid, the medical fluid container should contain a fluid in a liquid state, that is either a liquid medicine or a reconstituted medicine.

In the present disclosure, a “medical fluid container” (also known as a “vial”) is understood as a small glass or plastic bottle used for storing a medical fluid. The bottle comprises a cap and a body, wherein the cap includes a rubber stopper configured to be piercing by the needle of a syringe.

In the present disclosure, a “receiving fluid container” is understood as a container or bag configured to receive a medical fluid to be stored or mixed to another medical fluid (e.g. sterile saline solution or serum) contained inside the container or bag. An example of a receiving fluid container is an intravenous bag, also known as “IV bag” or “serum bag”, which is a sterile bag used to contain medical fluids to be administered to a patient intravenously.

It is noted that, in case of using a vial with a medicine in powdered form, then another medical fluid container containing a solvent or diluent may be used for retrieving a dose from it and then injecting said dose of solvent or diluent inside the vial containing the medicine in powdered form, thus carrying out the process of reconstitution inside the hermetic housing. Alternatively, when using an intravenous bag with serum, and the solvent to be used is serum, then a dose of serum may be retrieved from the intravenous bag and then injecting this dose of serum inside the vial containing the medicine in powdered form, thus carrying out the process of reconstitution inside the hermetic housing.

The device for transferring a medical fluid of the present disclosure is suitable for preparing intravenous medicaments or drugs, especially oncologic preparations or other hazardous substances, under a closed and hermetic environment, thus providing maximum safety to the operators which hand and mix the drugs, without compromising the stability of the drug.

Indeed, the device of the present disclosure allows to avoid the entry of contaminating agents into the hermetic housing to ensure aseptic handling of the drugs and the final preparation; and also allows to avoid filtration, spillage or traces of the drug used on the outside of the hermetic housing, work surfaces or surfaces of the connecting parts on their external faces. Thus, a total hermeticity of the device with the external environment is achieved.

Thanks to the compact configuration of the device of the present disclosure, a low-cost, portable, and disposable single use apparatus may be achieve. Furthermore, the device of the present disclosure avoids the need of infrastructure and specialised personnel. It allows access to oncological preparations to hospitals that for various reasons (whether economic, infrastructure, personnel or others), cannot do so; and in the case of hospitals that perform the standard process of the prior art, the device of the present disclosure would allow them to reduce costs, reallocate personnel and infrastructure resources, and improve their production. In addition, the reduction in time and simplicity of use considerably shortens the overall process, allowing more time for other work by qualified personnel.

Additionally, thanks to the safety, simplicity and low costs of the device of the present disclosure, it could provide access to treatment for patients in places that currently do not have the capacity to do so, such as remote areas or underdeveloped countries.

It is noted that the device of the present disclosure may be used for transferring any type of medical fluids, apart from hazardous substances. Thus, the device of the present disclosure is suitable for obtaining any medical preparations as required to be administered to a patient.

In summary, the device of the present disclosure allows to transfer a medical fluid in a safety and quickly manner, and at a lower cost than the standard process known in the prior art.

According to an example of the present disclosure, at least one of the outlet ports may comprise a connector element for sealingly connect the corresponding outlet port to a receiving fluid container.

In an example, each support assembly may comprise a fix support member configured to be fixedly attached to the inner side of the at least a wall of the body, and a movable support member configured to retain a medical fluid container in an operative position; and wherein the movable support member is configured to be releasably attached to the fix support member.

According to an example, the hermetic housing further may comprise an opening arranged at the body to insert the medical fluid container into the hermetic housing; and a cover configured to sealingly close the opening of the body.

In an example, the cover may comprise the deformable portion.

According to another aspect, the present disclosure also provides a kit for transferring a medical fluid, the kit comprising:
the device for transferring a medical fluid as disclosed herein; and
a fluid transfer instrument.

According to another aspect, the present disclosure also provides a method for transferring a medical fluid, the method comprising:
providing a device for transferring a medical fluid as disclosed herein;
moving a fluid transfer instrument connected to the connecting port to a loading position to retrieve a dose of the medical fluid from a medical fluid container arranged within the hermetic housing;
retrieving the dose of the medical fluid from the medical fluid container;
moving the fluid transfer instrument to a discharging position to transfer the retrieved dose of the medical fluid to an outlet port;
discharging the retrieved dose of the medical fluid to the outlet port.

### BRIEF DESCRIPTION OF THE DRAWINGS

Non-limiting examples of the present disclosure will be described in the following, with reference to the appended drawings, in which:

FIG. 1 is a perspective view of a device for transferring a medical fluid according to one example of the present disclosure;

FIG. 2 is an elevational view of the device shown in FIG. 1;

FIG. 3 is a schematical representation of the device of FIG. 1, showing the operational stage when the fluid transfer instrument joined to the connecting port is moved at the loading position for retrieving a dose of the medical fluid from a medical fluid container;
FIG. 4 is a schematical representation of the device of FIG. 1, showing the operational stage when the fluid transfer instrument joined to the connecting port is moved at the discharging position for transferring the retrieved dose of the medical fluid to an outlet port;

FIG. 5 is a perspective view of an example of a movable support member of the device of the present disclosure;

FIG. 6 is a perspective view of an example of a fix support member of the device of the present disclosure;

FIG. 7 is an elevational view of the movable support member of FIG. 5, illustrated in an operative position when in use;

FIG. 8 is a perspective exploded view of an example of a hermetic housing of the device of the present disclosure;

FIG. 9 is a schematic representation of a conventional syringe as an example of a fluid transfer instrument;

FIG. 10 is a perspective exploded view of an example of a connecting port of the device of the present disclosure;

FIG. 11 is an elevational exploded view of the connecting port of FIG. 10, and showing the syringe to be assembled;

FIG. 12 is a perspective exploded view of an example of an outlet port of the device of the present disclosure;

FIG. 13 is a cross-section assembled view of the outlet port of FIG. 12;

FIG. 14 is an elevational view of the outlet port of FIGS. 12 and 13, illustrated in an operative position when in use;

FIG. 15 is a perspective view of a device according to another example of the present disclosure, with an alternative example of the connecting port, and showing the cover in an opened position;

FIG. 16 is an elevational view of the device shown in FIG. 15;

FIG. 17 is a perspective exploded view of the connecting port shown in FIGS. 15 and 16, and illustrating the syringe to be assembled;

FIGS. 18 and 19 shown a perspective assembled view of the connecting port of FIG. 17, showing the plunger adaptor in an extended position and in a retracted position, respectively;

FIG. 20 is a perspective view of an alternative example of a deformable portion of the device of the present disclosure;

FIG. 21 is a schematic perspective view of an alternative example of a device of the present disclosure, showing the deformable portion and the cover arranged at different positions of the hermetic housing; and

FIG. 22 is a schematic representation of the operation method of the device of the present disclosure.

### DETAILED DESCRIPTION OF EXAMPLES

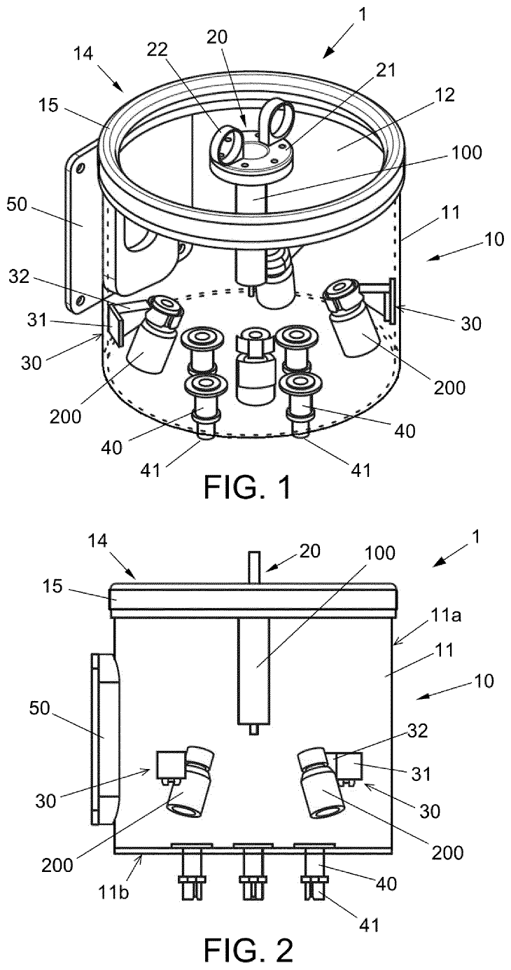

FIGS. 1 and 2 show a device 1 for transferring a medical fluid, according to one example of the present disclosure.

The device 1 of the present disclosure comprises a hermetic housing 10 comprising a body 11 and a deformable portion 12 sealingly attached to the body 11 to define a hermetical internal volume. In this example, the body 11 of the hermetic housing 10 comprises a cylindrical shape with a lateral wall 11a and a bottom wall 11b. Alternatively, other suitable shapes of the body may be considered, such as a parallelepiped shape or the like.

The device 1 of the present disclosure further comprises a connecting port 20 arranged at the deformable portion 12, wherein the connecting port 20 is configured to receive and sealingly attach a fluid transfer instrument 100 to be operated from the outside of the hermetic housing 10.

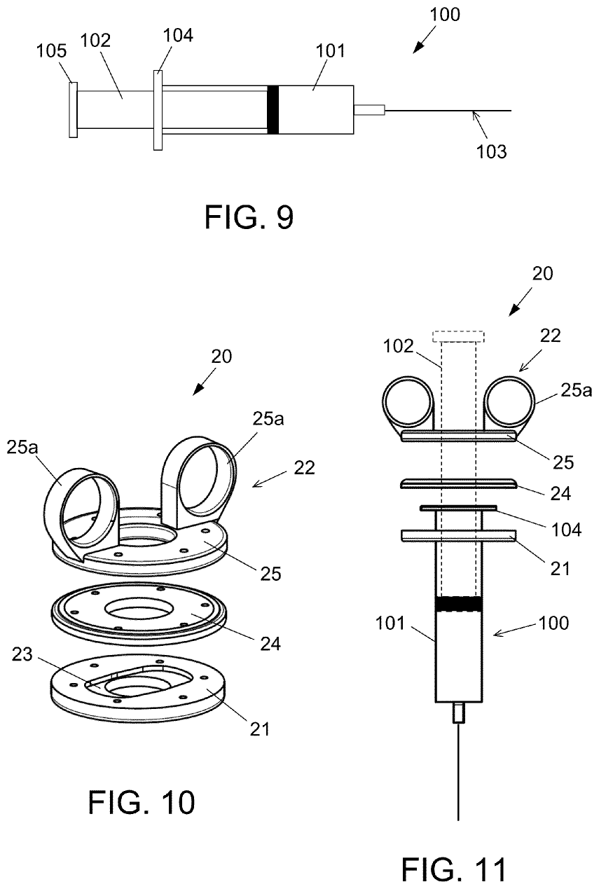

In this example, the fluid transfer instrument 100 is a conventional syringe. FIG. 9 schematically illustrates a conventional syringe 100 which comprises a barrel 101, a plunger 102 and a needle 103. The barrel 101 comprises a distal end wherein the needle 103 is connected in a sealingly manner, and a proximal end provided with a flange 104 to facilitates the handling thereof. The plunger 102 is displaceable inside the barrel 101 between a first direction (outwards) for drawing fluid into the syringe 100 and a second direction (inwards) tor expelling fluid from the syringe 100. The plunger 102 also includes a flange 105 for its handling.

For clarity, herein, the fluid transfer instrument and the syringe are indicated using the same referral number 100.

It is noted that instead of a conventional syringe, another type of instrument suitable for transferring a fluid as defined herein, may be used. Furthermore, in another examples, the fluid transfer instrument may be actuated by a pump (e.g. a pneumatic or hydraulic pump). In this case, the pump may be connected to a control unit to be controlled by the operator.

The device 1 of the present disclosure further comprises one or more support assemblies 30 configured to attach a medical fluid container 200 containing a medical fluid to an inner side of the at least a wall of the body 11 of the hermetic housing 10, as explained in more detail below. As can be seen in the example of FIGS. 1 and 2, the device 1 is equipped with four support assemblies 30 attached to the inner side of the lateral wall 11a. It is noted that several arrangements may also be considered, for example a different number of support assemblies 30 may be applied and/or the support assemblies 30 may be placed with another suitable distribution.

These support assemblies 30 allow the medical fluid containers 200 to be attached to the body 11 of the hermetic housing 10 with sufficient firmness to withstand the force applied by the operator when handling the syringe 100.

In this example, the medical fluid container 200 is a conventional vial, that is a small glass or plastic bottle used for storing a medical liquid (i.e. a liquid pharmaceutical product, e.g. hazardous medicines or drugs for oncological treatments). FIG. 7 schematically illustrates (in dashed lines) a vial 200 which comprises a cap 201 and a body 202, wherein the cap 201 includes in its upper side a rubber stopper configured to be pierced by the needle 103 of the syringe 100.

In the present disclosure, to carry out the process of transferring the medical liquid, the medical fluid container 200 should contain a fluid in a liquid state, that is either a liquid medicine or a reconstituted medicine, as explained above.

For clarity, herein, the medical fluid container and the vial are indicated using the same referral number 200.

The device 1 of the present disclosure further comprises one or more outlet ports 40 arranged at the body 11 and configured to selectively communicate the inside of the hermetic housing 10 with the outside thereof, as explained in more detail below. In the example shown in FIGS. 1 and 2, the device 1 includes four outlet ports 40 arranged at the bottom wall 11b of the body 11 of the hermetic housing 10. It is noted that different arrangements may be considered, for example a different number of outlet ports 40 may be applied and/or the outlet ports 40 may be placed with another suitable distribution, e.g. arranged at the lateral wall 11a of the body 11.

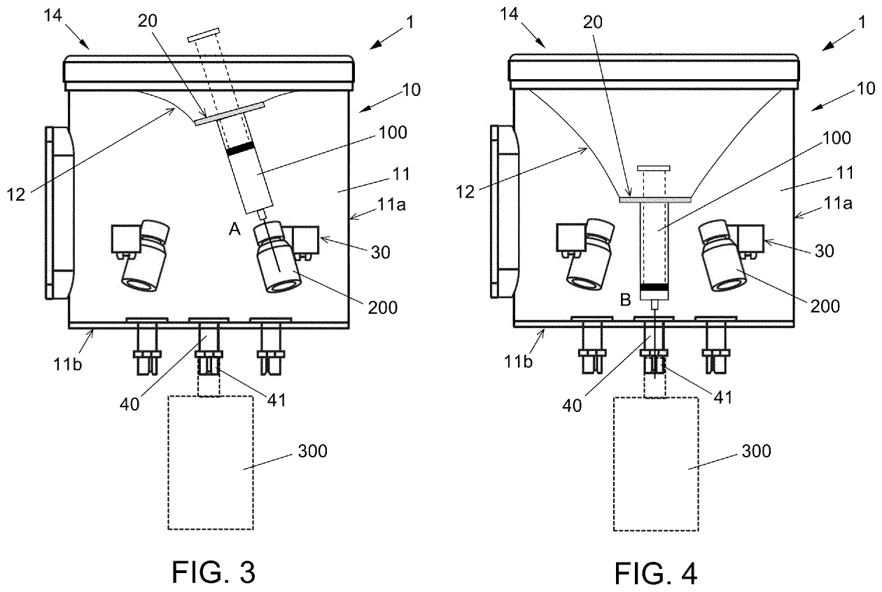

FIGS. 3 and 4 show schematically the operation of the device 1 when in use. As can be seen, the deformable portion 12 is configured to deform in such way that when the syringe 100 is sealingly attached to the connecting port 20, the deformable portion 12 moves the connecting port 20 between
a loading position A for retrieving a dose of the medical fluid from the vial 200 with the syringe 100 (see FIG. 3); and
a discharging position B for transferring the retrieved dose of the medical fluid to the outlet ports 40 from the syringe 100 (see FIG. 4).

In addition, at least one of the outlet ports 40 comprises a connector element 41 for sealingly connect the corresponding outlet port 40 to a receiving fluid container 300.

The outlet ports 40 coupled to the respective connector element 41 allow the receiving fluid container 300 to be gripped firmly, guiding the position of the syringe 100 and allowing the injection of drugs in a safe, trace-free manner, sealing the passage to possible pathogens.

In this example, the receiving fluid container is a conventional intravenous bag 300 (shown schematically with dashed lines in FIGS. 3 and 4), which may contain e.g. a sterile saline solution or serum to be administered to a patient intravenously. Alternatively, other types of suitable receiving fluid containers, e.g. a rigid container, may also be applied.

For clarity, herein, the receiving fluid container and the intravenous bag (or IV bag) are indicated using the same referral number 300.

The device 1 of the present disclosure further comprises a support structure 50 (see for example FIGS. 1 and 2) connected to the hermetic housing 10 and configured to rotate the hermetic housing 10, e.g. by means of a rotating arm (not shown), when necessary. Therefore, the operator may rotate the hermetic housing 10 to a suitable tilted position, e.g. upside down, in order to facilitate the process of retrieving a dose of the medical fluid from the vial 200 in the loading position. Moreover, the support structure 50 may be connected to a portable pedestal, a working table, or the like.

In another examples, the device 1 may comprise an engine (not shown) coupled to the rotating arm to automate the rotation of the hermetic housing 10. In addition, the engine may also be programmed by a control unit to produce a repeated shaking movement, which is suitable when a process of reconstitution is required, thus facilitating the mixing of a powdered drug with a solvent.

In another examples, the support structure 50 further may comprises a filter (not shown) connected to the inside of the hermetic housing 10 through an opening formed in the body 11.

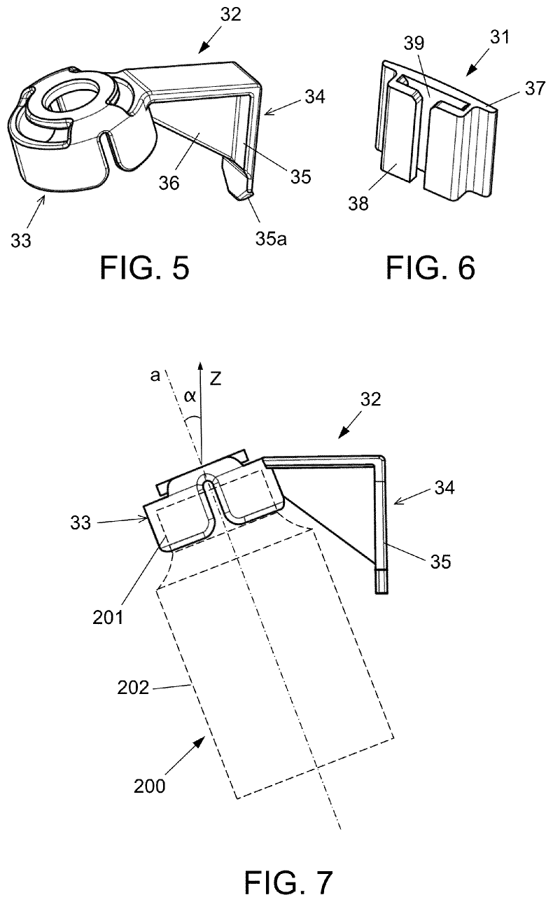

FIGS. 5 to 7 show in more detail an example of a support assembly 30, as explain below.

In this example, each support assembly 30 comprises a fix support member 31 and a movable support member 32 (see FIGS. 1 and 2). On the one hand, the fix support member 31 is configured to be fixedly attached to the inner side of the at least a wall, in this example the lateral wall 11a of the body 11. On the other hand, the movable support member 32 is configured to retain a vial 200 in an operative position. Indeed, the movable support member 32 is configured to be releasably attached to the fix support member 31, as explained in the following.

According to an example shown in FIG. 5, the movable support member 32 comprises an engaging portion 33 configured as a cylindrical body adapted to embrace and retain by pressure (e.g. snap fit) the cap 201 of the vial 200 (see FIG. 7), and a hanger 34 configured to be releasably attached to the fix support member 31. In this example, the hanger 34 comprises an insertion tongue 35 connected to the engaging portion 33 by a bridge 36.

In this example, as can be seen in FIG. 6, the fix support member 31 comprises a fastening surface 37 configured to be fixedly attached to the inner side of the at least a wall (in this example, the lateral wall 11a) of the body 11; and a receiving portion 38 arranged opposite to the fastening surface 37, wherein the receiving portion 38 is provided with an open channel 39 adapted to receive and secure the insertion tongue 35 of the movable support member 32. Furthermore, the insertion tongue 35 comprises a lower portion with a protruding tab 35a intended to retain by pressure (e.g. snap fit) the insertion tongue 35 to a lower edge of the receiving portion 38. This arrangement allows the vial 200 to be fixedly secured to the body 11 of the hermetic housing 10, in any tilted position of the hermetic housing 10.

It is noted that each vial 200 is attached to a movable support member 32 in a space outside the hermetic housing 10. Then, each movable support member 32 supporting a vial 200 is introduced inside the hermetic housing 10, as explained below, and attached to a respective fix support member 31.

Furthermore, in this example, as can be appreciated in FIG. 7, the axis “a” of the cylindrical body of engaging portion 33 is oriented with a predetermined angle of inclination “α” with respect to a vertical direction Z. In the examples described herein, the “vertical direction Z” is understood as a direction substantially parallel to the lateral wall 11a and substantially perpendicular to the bottom wall 11b of the body 11. Indeed, the inclined engaging portion 33 allows to achieve an operative position of the vial 200 in use, thus facilitating the insertion of the needle 103 of the syringe 100 into the cap 201 of the vial 200, as can be seen in FIG. 3.

In other examples, the movable support member 32 and the fix support member 31 may comprise other suitable configurations.

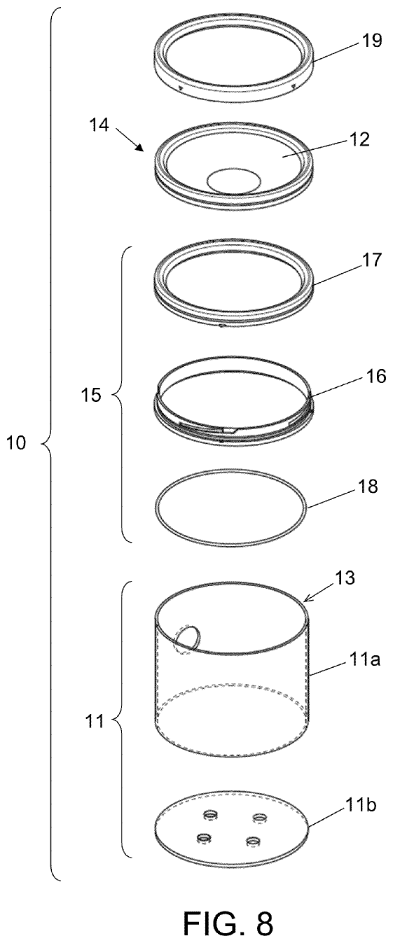

FIG. 8 shows in more detail an example of a hermetic housing 10, as explain hereafter.

In this example, the hermetic housing 10 comprises an opening 13, which is arranged at the upper side of the body 11, i.e. at the opposite side of the bottom wall 11b. The opening 13 allows to insert each movable support member 32 supporting a vial 200 (as previously disclosed) into the hermetic housing 10, and then to attach the movable support member 32 with the vial 200 to a respective fix support member 31. Furthermore, the opening 13 also facilitate the previous operation of assembling the fix support members 31 and the outlet ports 40 to the body 11 of the hermetic housing 10.

In the described example, the hermetic housing 10 further comprises a cover 14 configured to sealingly close the opening 13, as explained below. In this example, the cover 14 has a circular shape which is a suitable configuration to be sealingly coupled to the opening 13 of the cylindrical shape of the body 11.

In this example, the cover 14 comprises the deformable portion 12 as a single piece. As can be seen for example in FIGS. 1 and 8, the deformable portion 12 is configured as a circular membrane, in which the connecting port 20 may be arranged at the center of said circular membrane. In this case, a through hole is made in the center of said circular membrane to allow the passage of the syringe 100.

Moreover, the body 11 and the deformable portion 12 may be made of a transparent or translucent material to allow the operator to visualize the interior of the hermetic housing 10 while manipulates the syringe 100 for carrying out the process of transferring the medical fluid to perform the medical preparations.

As can be seen for example in FIGS. 1 and 2, the hermetic housing 10 further comprises a sealing arrangement 15 for coupling the cover 14 to the body 11, in order to sealingly close the opening 13 of the body 11, as explained in more detail hereafter.

As shown in more detail in FIG. 8, in this example, the sealing arrangement 15 comprises a lower disc 16 connected to the body 11 and an upper disc 17 connected to the cover 14. In addition, a sealing element 18, such as a watertight O-ring or sealing gasket, is arranged at the perimeter of the opening 13 of the body 11 in a position underneath the lower disc 16.

Furthermore, the upper disc 17 is configured to be attached to the lower disc 16 by a cooperating coupling. In this example, the cooperating coupling is a threaded coupling (visible in FIGS. 8, 15 and 16), such that the upper disc 17 may be threaded onto the lower disc 16 to sealingly close the opening 13 of the body 11. In fact, the upper disc 17 comprises an internal threaded surface to be coupled to an external surface of the lower disc 16. It is noted that another suitable cooperating coupling may be applied, as for example a coupling by pressure (snap fit), a hinge, among others.

As can be seen in FIG. 8, the hermetic housing 10 further comprises an exterior concentrical disc 19 configured to be attached by pressure to the upper disc 17, such that the perimeter of the cover 14 may be retained between both discs 17 and 19. In this example, the cover 14 comprises the whole deformable portion 12, as explained above.

FIGS. 10 and 11 show in more detail an example of a connecting port 20, as explain below.

In this example, the connecting port 20 comprises an anchoring disc 21 to be sealingly attached to the deformable portion 12, and a handle 22 to facilitate the manipulation of the syringe 100 from the outside of the hermetic housing 10, as explained in the following.

In this example, the anchoring disc 21 is provided with a central through hole for the passage of the syringe 100. The anchoring disc 21 is provided with a recess 23 (see FIG. 10) adapted to receive the flange 104 of the barrel 101 of the syringe 100 when it is assembled. Furthermore, a retainer disc 24 with a central through hole is attached to the anchoring disc 21 (e.g. with screws). In the assembled position, the anchoring disc 21 is placed underneath the deformable portion 12 and the retainer disc 24 is placed over the deformable portion 12. In this way, the syringe 100 is secured to the deformable portion 12 in a sealingly manner.

In this same example, the handle 22 comprises a support disc 25 provided with two ergonomic rings 25a to be manipulated by an operator. In the assembled position, the support disc 25 is attached to the retainer disc 24 (e.g. with screws), which in turn is attached to the anchoring disc 21.

FIG. 11 shows a schematic exploded view of the connecting port 20 with the syringe 100 to be assembled. It is noted that the plunger 102 (shown in dashed lines for clarity) of the syringe 100 protrudes from the support disc 25 of the handle 22 in order to facilitate the manipulation of the said plunger 102 from the outside of the hermetic housing 10.

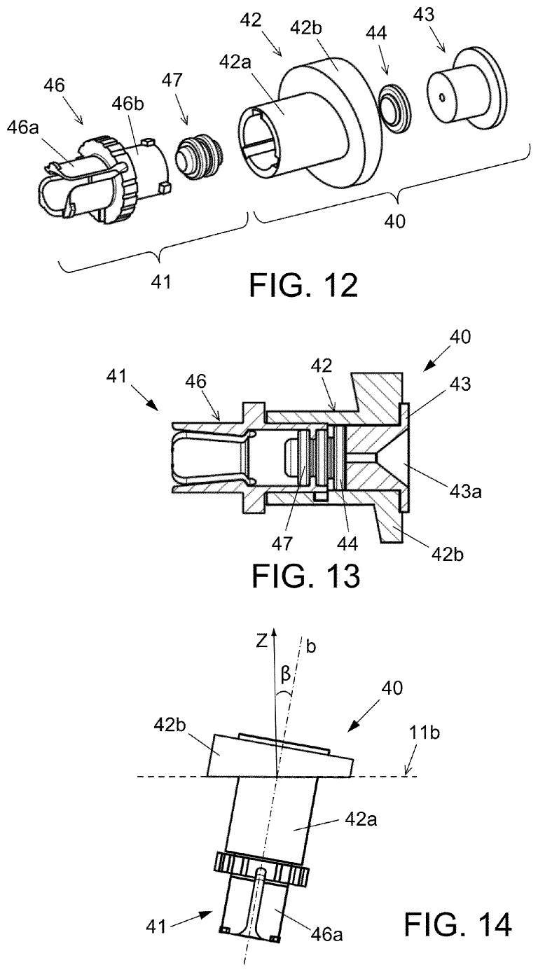

FIGS. 12 to 14 show in more detail an example of an outlet port 40 coupled to a connector element 41, as explain below.

On the one hand, in this example, the outlet port 40 comprises:
A tubular support body 42 with a distal portion 42a configured to be inserted through a hole performed in a wall of the body 11 of the hermetic housing 10, in this example in the bottom wall 11b, and a proximal annular seat 42b to be fixedly attached to the inner side of said bottom wall 11b. In this way, the distal portion 42a of the tubular support body 42 protrudes outwards from the body 11.
A needle guide 43 arranged inside the tubular support body 42 through the proximal annular seat 42b, and wherein the needle guide 43 comprises an inner funnel 43a intended to direct the trajectory of the needle 103 of the syringe 100 inside the tubular support body 42.
A sealing rubber 44 arranged inside the tubular support body 42 in a position adjacent to the outlet of the inner funnel 43a, thus allowing to seal the body 11 of the hermetic housing 10.

On the other hand, in this example, the connector element 41 comprises:
A tubular connector body 46 with a distal portion 46a configured to be attached (e.g. a snap fit) to the intravenous bag 300 in a sealing manner; and a proximal portion 46b configured to be inserted through the distal portion 42a of the tubular support body 42 and attached thereof in a releasable manner (e.g. by a snap fit).
A sealing rubber 47 arranged inside the proximal portion 46b, thus allowing to seal the intravenous bag 300.

In the assembled position (see FIG. 13), that is when the connector element 41 is coupled to the outlet port 40, both sealing rubbers 44 and 47 (e.g. made of silicone) allow the passage of the needle 103 of the syringe 100 until the interior of the intravenous bag 300. Moreover, both sealing rubbers 44 and 47 are compressed to each other to produce a seal against the intravenous bag 300, and also to clean any traces in the path of the needle 103 of the syringe 100. After use, when the connector element 41 is removed from the outlet port 40, each sealing rubber 44 and 47 provides a seal for the body 11 of the hermetic housing 10 and for the intravenous bag 300, respectively.

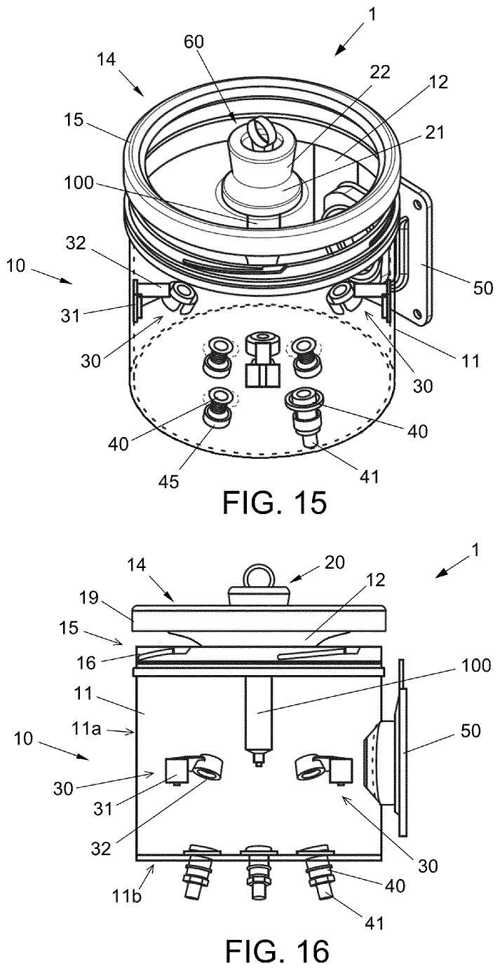

Furthermore, when an outlet port 40 is not used or a connector element 11 is removed after use, a cap or stopper 45 (visible in FIG. 15) may be used to sealingly close the distal portion 42a of the outlet port 40.

FIG. 14 shows the outlet port 40 coupled to a connector element 41 in an operative position when in use (the bottom wall 11b of the body 11 is illustrated in dashed lines). In this example, the proximal annular seat 42b has a decreasing thickness so that when the outlet port 40 is assembled to the bottom wall 11b of the body 11 of the hermetic housing 10, the axis “b” of the tubular support body 42 adopts an angle of inclination “B” with respect to a vertical direction Z. As explained above, in the examples described herein, the “vertical direction Z” is understood as a direction substantially parallel to the lateral wall 11a and substantially perpendicular to the bottom wall 11b of the body 11. Indeed, the inclined tubular support body 42 (see e.g. FIGS. 14 and 16) allows to achieve an operative position necessary to facilitate the insertion of the needle 103 of the syringe 100 inside the needle guide 43 of the outlet port 40.

In other examples, the outlet port 40 and the connector element 41 may comprise other suitable configurations.

FIGS. 15 and 16 shown another example of the device 1 of the present disclosure, comprising an alternative example of a connecting port 60 as explained below. For clarity, the common features of the device 1 shown in FIGS. 15 and 16 with respect to the device 1 of the previous example (see e.g. FIGS. 1 and 2), are indicated using the same referral numeral. Furthermore, as indicate above, FIGS. 15 and 16 illustrate the cover 14 in an opened position to show the threaded coupling of the sealing arrangement 15.

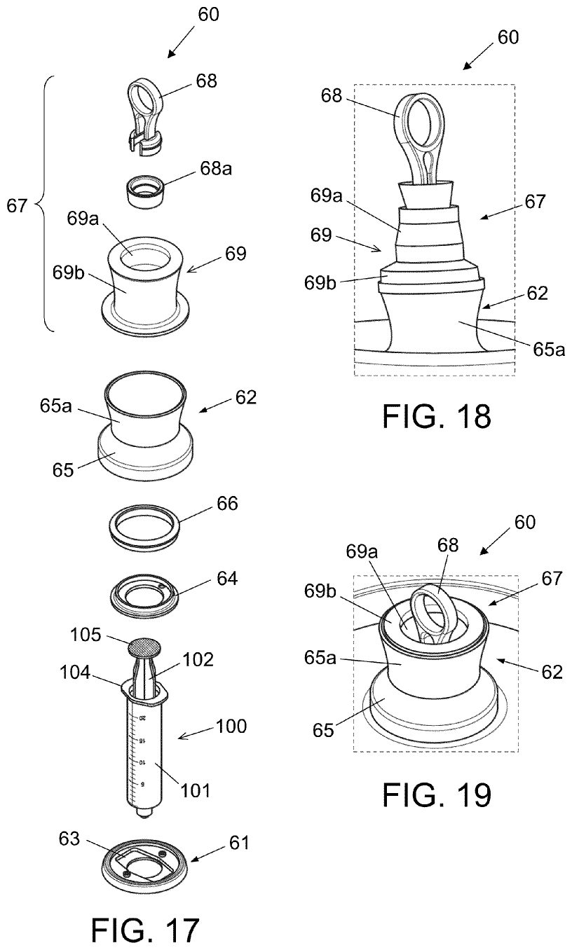

As can be seen in more detail in FIGS. 17 to 19, the connecting port 60 of this alternative example comprises an anchoring disc 61 to be sealingly attached to the deformable portion 12, and a handle 62 to facilitate the manipulation of the syringe 100 from the outside of the hermetic housing 10, as explained in the following.

In this alternative example, the anchoring disc 61 is provided with a central through hole for the passage of the syringe 100. The anchoring disc 61 is provided with a recess 63 adapted to receive the flange 104 of the barrel 101 of the syringe 100 when it is assembled. Furthermore, a retainer disc 64 with a central through hole is attached to the anchoring disc 61 (e.g. with screws). In the assembled position, the anchoring disc 61 is placed underneath the deformable portion 12 and the retainer disc 64 is placed over the deformable portion 12. In this way, the syringe 100 is secured to the deformable portion 12 in a sealingly manner.

In this alternative example, the handle 62 comprises a tubular grip 65 with an external ergonomic surface 65a to be manipulated by an operator, and an internal cavity for the passage of the syringe 100.

In this alternative example, the connecting port 60 further comprises a plunger adaptor 67 to be coupled to a flange 105 of the plunger 102 of the syringe 100 to facilitate the manipulation of the plunger 102 from the outside of the hermetic housing 10, as explained in more detail in the following.

The plunger adaptor 67 comprises a gripper 68 to be manipulated by an operator, and a compressor ring 68a for connecting said gripper 68 to the flange 105 of the plunger 102. In addition, the plunger adaptor 67 further comprises a protection cap 69 for covering the plunger 102 of the syringe 100 in a sealingly manner. This protection cap 69 comprises a deformable upper portion 69a attached to the compressor ring 68a and a non-deformable lower portion 69b arranged into the internal cavity of the tubular grip 65 of the handle 62.

In addition, an intermediate connector disc 66 is attached to the retainer disc 64 (e.g. snap fit), which in turn is attached to the anchoring disc 61, as explained above. In the assembled position, the non-deformable lower portion 69b of the protection cap 69 is attached to the intermediate connector disc 66, and the handle 62 is placed around the non-deformable lower portion 69b and secured thereto.

FIGS. 18 and 19 shown a perspective assembled view of the connecting port 60 of FIG. 17, showing the plunger adaptor 67 in an extended position and in a retracted position, respectively. In this way, when the plunger 102 is moved outwards for retrieving a dose of the medical fluid, the protection cap 69 of the plunger adaptor 67 is arranged in an extended position protruding from the handle 62 (see FIG. 18); and when the plunger 102 is moved inwards for discharging the dose of the medical fluid, the protection cap 69 of the plunger adaptor 67 is in a folded position inside the handle 62 (see FIG. 19).

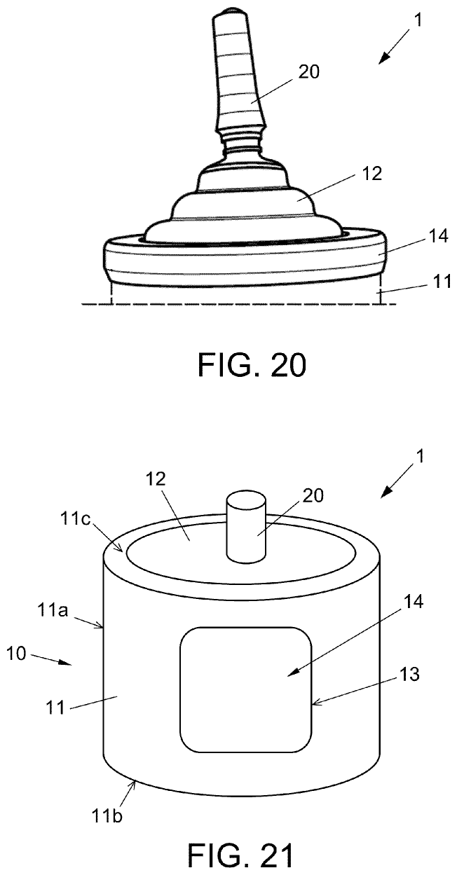

According to another example of the device 1 of the present disclosure, shown partially in FIG. 20, the deformable portion 12 may be configured as a bellows or dome-shaped body with a plurality of concentrical circular regions, such that the connecting port 20 (shown schematically) is arranged at the centre of said concentrical circular regions, that is in the upper region. In this case, this upper region includes a through hole for the passage of the syringe 100.

According to another example of the device of the present disclosure, shown schematically in FIG. 21, the cover 14 does not comprises the deformable portion 12. In this example, the cover 14 is attached to an opening 13 performed in a wall of the body 11, e. g in the lateral wall 11a, and the deformable portion 12 is placed in another position different than the position of the cover, for example in an upper wall 11c of the body 11.

Furthermore, the present disclosure also provides a kit for transferring a medical fluid, the kit comprising the device 1 for transferring a medical fluid as disclosed herein (see e.g. FIGS. 1 and 15), and a fluid transfer instrument 100, e.g. a syringe.

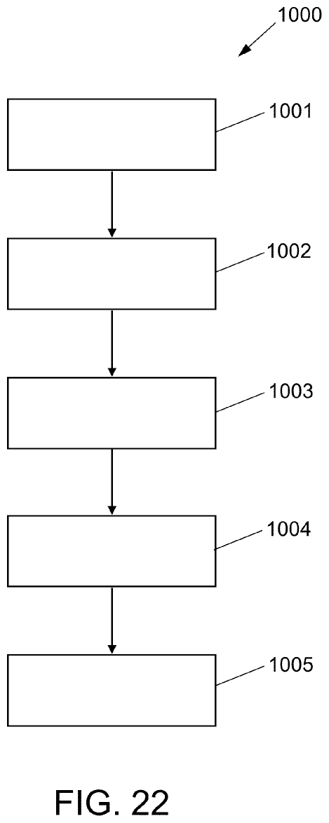

In some examples, the kit also may comprise one or more medical fluid containers (vials) 200, and/or one or more receiving fluid containers 300, e.g. a intravenous bag. FIG. 22 shows a schematic representation of an example of a method 1000 for transferring a medical fluid according to the present disclosure, the method comprising:
providing a device 1 for transferring a medical fluid as disclosed herein (see e.g. FIGS. 1 and 15), as represented in block 1001;
moving a fluid transfer instrument 100 (e.g. a syringe) connected to the connecting port 20, 60 to a loading position A (see FIG. 3) to retrieve a dose of the medical fluid from a medical fluid container (a vial) 200 arranged within the hermetic housing 10, as represented in block 1002;
retrieving the dose of the medical fluid from the medical fluid container 200, as represented in block 1003;
moving the fluid transfer instrument 100 to a discharging position B (see FIG. 4) to transfer the retrieved dose of the medical fluid to an outlet port 40, as represented in block 1004; and
discharging the retrieved dose of the medical fluid to the outlet port 40, as represented in block 1005.

The method disclosed may also comprise the stage of rotating the hermetic housing 10, when necessary, to establish a tilting position (e.g. upside down) to facilitate the retrieving of the dose of medical fluid from a medical fluid container 200.

It is noted that the device 1 of the present disclosure may be provided with one or more medical fluid containers (vials) 200, each containing the same or different medical fluids, and one or more outlet ports 40 with respective connecting elements 41 to be connected to a respective receiving fluid container 300, e.g. an intravenous bag. Hence, several doses of medical preparations may be performed inside the hermetical housing 10 as necessary to be administered to a patient or patients. Therefore, the blocks 1002 to 1005 of the method disclosed may be repeated until all the required medical preparations are obtained.

As explained above, in case of using a vial 200 with a medicine in powdered form, then another vial containing a solvent or diluent may be used. In this case, before the stage of moving the fluid transfer instrument 100 to a loading position A (as represented in block 1002), the method comprises moving the syringe 100 to said vial containing the solvent or diluent to retrieve a dose, and then moving the syringe 100 to the vial containing the medicine in powdered form; and after this, moving the hermetic housing 10 in a repetitive shaking movement to perform the reconstitution.

Alternatively, when using an intravenous bag 300 with serum and the solvent to be used is serum, then before the stage of the block 1002, the method comprises moving the syringe 100 to the intravenous bag 300 to retrieve a dose of serum, and then moving the syringe 100 to the vial containing the medicine in powdered form; and after this, moving the hermetic housing 10 in a repetitive shaking movement to perform the reconstitution.

Furthermore, when using a medical fluid classified as a hazardous medicine, for example drugs for oncological treatments, the device 1 should be discarded correctly after use, in accordance with the regulations stablished.

It is noted that before the stage of moving the fluid transfer instrument 100 to a loading position A (as represented in block 1002), the method further may comprise preparing the device 1 to an operative mode comprising:
connecting a fluid transfer instrument 100 to the connecting port 20, 60;
attaching at least a medical fluid container 200 to a respective movable support member 32;
introducing through the opening 13 of the body 11 of the hermetic housing 10 each movable support member 32 supporting a medical fluid container 200;
coupling each movable support member 32 supporting the medical fluid container 200 to a respective fix support member 31;
sealing the body 11 of the hermetic housing 10 with the cover 14 to close the opening 13 of the body 11; and
connecting at least a receiving fluid container 300 to a respective outlet port 40 by a connector element 41.

The device may be prepared to the operative mode in a factory, in order to provide a device with the required components and supplies already assembled into the hermetic housing. In this case, the device will be transported to a laboratory, hospital, or the like, ready to be used by an operator.

Alternatively, the device may be directly prepared to the operative mode by an operator. In this case, the operator has more flexibility to assemble specific components and supplies into the hermetic housing for carrying out the required medical preparations according to the treatment for each patient.

Although only a number of examples have been disclosed herein, other alternatives, modifications, uses and/or equivalents thereof are possible. Furthermore, all possible combinations of the described examples are also covered. Thus, the scope of the present disclosure should not be limited by particular examples, but should be determined only by a fair reading of the claims that follow. If reference signs related to drawings are placed in parentheses in a claim, they are solely for attempting to increase the intelligibility of the claim, and shall not be construed as limiting the scope of the claim.

What is claimed is:

1. A device for transferring a medical fluid, the device comprising:
a hermetic housing comprising
a body provided with at least a wall; and
a deformable portion sealingly attached to the body to define a hermetical internal volume;
a connecting port arranged at the deformable portion the connecting port configured to receive and sealingly attach a fluid transfer instrument to be operated from the outside of the hermetic housing;
one or more support assemblies configured to attach a medical fluid container containing a medical fluid to an inner side of the at least a wall of the body of the hermetic housing; and
one or more outlet ports arranged at the body and configured to selectively communicate the inside of the hermetic housing with the outside thereof; and
wherein the deformable portion is configured to deform in such way that when the fluid transfer instrument is sealingly attached to the connecting port, the deformable portion moves the connecting port between
a loading position for retrieving a dose of the medical fluid from the medical fluid container with the fluid transfer instrument; and
a discharging position for transferring the retrieved dose of the medical fluid to the outlet ports from the fluid transfer instrument

2. The device according to claim 1, wherein at least one of the outlet ports comprises a connector element for sealingly connect the corresponding outlet port to a receiving fluid container.

3. The device according to claim 1, wherein each support assembly comprises
a fix support member configured to be fixedly attached to the inner side of the at least a wall of the body, and
a movable support member configured to retain a medical fluid container in an operative position;
and wherein the movable support member is configured to be releasably attached to the fix support member.

4. The device according claim 1, wherein the hermetic housing further comprises
an opening arranged at the body to insert the medical fluid container into the hermetic housing; and
a cover configured to sealingly close the opening of the body.

5. The device according to claim 4, wherein the hermetic housing further comprises a sealing arrangement for coupling the cover to the body, in order to sealingly close the opening of the body.

6. The device according to claim 4, wherein the cover comprises the deformable portion.

7. The device according to claim 4, wherein the body of the hermetic housing comprises a cylindrical shape with a lateral wall and a bottom wall, wherein the opening is arranged at the upper side of the body, that is at the opposite side of the bottom wall.

8. The device according to claim 5, wherein the sealing arrangement comprises a lower disc connected to the body and an upper disc connected to the cover, wherein the upper disc is configured to be attached to the lower disc by a cooperating coupling so as to coupling the cover to the body.

9. The device according to claim 1, further comprising a support structure connected to the hermetic housing and configured to rotate the hermetic housing.

10. A kit for transferring a medical fluid, the kit comprising:
the device according to claim 1; and
a fluid transfer instrument

11. The kit according to claim 10, wherein the fluid transfer instrument is a syringe, the syringe comprising a barrel a plunger and a needle.

12. The kit according to claim 11, wherein the connecting port comprises
an anchoring disc to be sealingly attached to the deformable portion, and wherein the anchoring disc is configured to be assembled with a flange of the barrel of the syringe to secure the syringe to the deformable portion; and
a handle to be coupled to the anchoring disc to facilitate the manipulation of the syringe from the outside of the hermetic housing.

13. The kit according to claim 12, wherein the connecting port further comprises a plunger adaptor to be coupled to a flange of the plunger to facilitate the manipulation of the plunger from the outside of the hermetic housing.

14. A method for transferring a medical fluid, the method comprising:
providing a device for transferring a medical fluid according to claim 1;
moving a fluid transfer instrument connected to the connecting port a loading position to retrieve a dose of the medical fluid from a medical fluid container arranged within the hermetic housing;
retrieving the dose of the medical fluid from the medical fluid container;
moving the fluid transfer instrument to a discharging position to transfer the retrieved dose of the medical fluid to an outlet port;
discharging the retrieved dose of the medical fluid to the outlet port.

15. The method according to claim 14, wherein before moving the fluid transfer instrument to a loading position, the method further comprises preparing the device to an operative mode comprising:
connecting a fluid transfer instrument to the connecting port;
attaching at least a medical fluid container to a respective movable support member;
introducing through an opening of the body of the hermetic housing each movable support member supporting a medical fluid container;
coupling the movable support member supporting the medical fluid container to a respective fix support member;
sealing the body of the hermetic housing with a cover to close the opening of the body;
connecting at least a receiving fluid container to a respective outlet port by a connector element.
